(19) United States
(12) Patent Application Publication
(10) Pub. No.: US 2004/0001551 A1
(43) Pub. Date: Jan. 1, 2004

(54) Data transmission circuit and method for reducing leakage current

(75) Inventors: Kyu-young Chung, Seoul (KR); Jae-cheol Han, Suwon-city (KR)

Correspondence Address: Frank Chau, F. CHAU & ASSOCIATES, LLP, 1900 Hempstead Turnpike, Suite 501, East Meadow, NY, 11554, US

(73) Assignee: Samsung Electronics Co., Ltd.

(21) Appl. No.: 10/390,855

(22) Filed: Mar. 18, 2003

(30) Foreign Application Priority Data
Jun. 27, 2002 (KR) 2002-36410

(51) Int. Cl. H04B 3/00; H04L 25/00

(52) U.S. Cl. 375/257

(57) ABSTRACT

A data transmission circuit in which leakage current is not generated during transmission of data and a method of transmitting data using the same. The data transmission circuit, which has input and output terminals and transmits data input to the input terminal to the output terminal, comprises a control circuit generating a control signal; and a transmission circuit pulling up the level of the output terminal to the level of a power source voltage or transmitting the data to the output terminal, in response to the control signal. The transmission circuit pulls up the level of the output terminal to the level of the power source voltage in response to the control signal having a logic high level, irrespective of whether the data is being input to the input terminal or the input terminal is open. Also, the transmission circuit transmits the data to the output terminal in response to the control signal having a logic low level.

### BACKGROUND OF THE INVENTION

This application claims priority to Korean Patent Application No. 2002-36410, filed Jun. 7, 2002 in the Korean Intellectual Property Office (KIPO), which is incorporated by reference herein in its entirety.

1. Field of the Invention

The present invention relates to a data transmission circuit and a method for transmitting data used by the same, and more particularly, to a data transmission circuit in which leakage current is not generated during transmission of data and a method of transmitting data used by the same.

2. Description of the Related Art

FIG. 1 is a circuit diagram of a conventional pull-up input circuit 10. Referring to FIG. 1, the pull-up input circuit 10 includes an input pad 13, a protection circuit 15, a pull-up transistor 17, and an input buffer 19.

In a case where no signal is input to an input pin 11, i.e., the input pin 11 is open, the pull-up input circuit 10 pulls up the level of an output signal Vout to the level of the power source voltage VDD. When a signal of a low level is applied to the input pin 11, the pull-up input circuit 10 outputs the low level as the output signal Vout. When a signal of a high level is applied to the input pin 11, the pull-up input circuit 10 outputs the high level as the output signal Vout.

When a low-level signal is applied to the input pin 11, a small amount of leakage current flows through the pull-up transistor 17. One way to avoid this is to increase a turn-on resistance of the pull-up transistor 17 to reduce the leakage current. However, the leakage current flowing through the pull-up transistor 17 cannot be completely removed by increasing the turn on resistance.

FIG. 2 is a circuit diagram of a conventional pull-down input circuit 20. Referring to FIG. 2, the pull-down input circuit 20 includes an input pad 23, a protection circuit 25, a pull-down transistor 27, and an input buffer 29. The pull-down input circuit 20 is disadvantageous in that a small amount of a leakage current flows through the pull-down transistor 27 when a high-level signal is applied to an input pin 21.

FIG. 3 is a circuit diagram of a conventional pull-up output circuit 30. The pull-up output circuit 30 includes an output buffer 31, a pull-up transistor 33, a protection circuit 35, and an output pad 37. During transmission of an input signal Vin of a low level, a small amount of leakage current flows through the pull-up transistor 33.

FIG. 4 is a circuit diagram of a conventional pull-down output circuit 40. The pull-down output circuit 40 includes an output buffer 41, a pull-down transistor 43, a protection circuit 45, and an output pad 47. During transmission of an input signal Vin of a high level, a small amount of a leakage current flows through the pull-down transistor 43.

### SUMMARY OF THE INVENTION

It is an aspect of the present invention to provide a data transmission circuit through which a leakage current does not flow during transmission of input data, when an input pin is open or data is input to the input pin according to an application, and a method of transmitting data used by the same.

According to one aspect of the present invention, there is provided a data transmission circuit comprising an input terminal and an output terminal and transmits data input to the input terminal to the output terminal, the data transmission circuit including a control circuit generating a control signal; and a transmission circuit pulling up the level of the output terminal to the level of a power source voltage or transmitting the data to the output terminal, in response to the control signal.

The transmission circuit pulls up the level of the output terminal to the level of the power source voltage in response to the control signal having a logic high level, irrespective of whether the data is being input to the input terminal or the input terminal is open. The transmission circuit also transmits the data to the output terminal in response to the control signal having a logic low level.

To achieve another aspect of the present invention, there is provided a data transmission circuit comprising an input terminal and an output terminal and transmits data input to the input terminal to the output terminal, the data transmission circuit including a control circuit generating a control signal; and a transmission circuit pulling down the level of the output terminal to the level of a grounding power source or transmitting the data to the output terminal, in response to the control signal.

The transmission circuit pulls down the level of the output terminal to the level of the grounding power source in response to the control signal having a logic low level, irrespective of whether the data is being input to the input terminal or the input terminal is open. The transmission circuit also transmits the data to the output terminal in response to the control signal having a logic high level.

To achieve still another aspect of the present invention, there is provided a method of transmitting data input to an input terminal to an output terminal, the method including generating a control signal; and pulling up the level of the output terminal to the level of power source voltage or transmitting the data to the output terminal, in response to the control signal.

Transmitting the data includes pulling up the level of the output terminal to the level of power source voltage in response to the control signal having a logic high level, irrespective of whether the data is being input to the input terminal or input terminal is open. During the transmitting of the data, the data is transmitted to the output terminal in response to the control signal having a logic low level.

To achieve still another aspect of the present invention, there is provided a method of transmitting data input to an input terminal to an output terminal, the method including generating a control signal; and pulling down the level of the output terminal to the level of a grounding power source or transmitting the data to the output terminal, in response to the control signal.

Transmitting the data includes pulling down the level of the output terminal to the level of the grounding power source in response to the control signal having a logic low level, irrespective of whether he data is being input to the input terminal or the input terminal is open. During the transmitting of the data, the data is transmitted to the output terminal in response to the control signal having a logic high level.

To achieve still another aspect of the present invention, there is provided a data transmission circuit comprising an input terminal and an output terminal and transmits data input to the input terminal to the output terminal, the data transmission circuit comprising: a pull-up mode; and a normal mode, wherein the level of the output terminal is pulled up to the level of power source voltage in the pull-up mode and the data is transmitted to the output terminal in the normal mode.

To achieve still another aspect of the present invention, there is provided a method of transmitting data input to an input terminal to an output terminal, the method comprising checking if a present mode is a pull-up mode or a normal mode; and pulling up the level of the output terminal to the level of power source voltage in the pull-up mode and transmitting the data to the output terminal in the normal mode.

To achieve still another aspect of the present invention, there is provided a data transmission circuit comprising an input terminal and output terminal and transmits data input to the input terminal to the output terminal, the data transmission circuit comprising a pull-down mode; and a normal mode, wherein the level of the output terminal is pulled up to the level of power source voltage in the pull-down mode and the data is transmitted to the output terminal in the normal mode. When the input terminal is open, the level of the output terminal is pulled down to the level of the power source voltage in the pull-down mode.

To achieve still another aspect of the present invention, there is provided a method of transmitting data input to an input terminal to an output terminal, the method comprising checking if a present mode is a pull-down mode or a normal mode; and pulling down the level of the output terminal to the level of a grounding power source in the pull-down mode and transmitting the data to the output terminal in the normal mode.

### BRIEF DESCRIPTION OF THE DRAWINGS

The above aspects of the present invention and advantages of the present invention will become more apparent by describing in detail a preferred embodiment thereof with reference to the attached drawings in which:

FIG. 1 is a circuit diagram of a conventional pull-up input circuit;

FIG. 2 is a circuit diagram of a conventional pull-down input circuit;

FIG. 3 is a circuit diagram of a conventional pull-up output circuit;

FIG. 4 is a circuit diagram of a conventional pull-down output circuit;

FIG. 5 is a circuit diagram of a first data transmission circuit according to an embodiment of the present invention;

FIG. 6 is a circuit diagram of a second data transmission circuit according to an embodiment of the present invention;

FIG. 7 is a circuit diagram of a third data transmission circuit according to an embodiment of the present invention;

FIG. 8 is a circuit diagram of a fourth data transmission circuit according to an embodiment of the present invention;

FIG. 9 is a circuit diagram of a pull-up circuit shown in FIGS. 5 and 7;

FIG. 10 is a circuit diagram of a pull-down circuit shown in FIGS. 6 and 8;

FIG. 11 is a diagram of the relationship between an input and an output of the first data transmission circuit of FIG. 5;

FIG. 12 is a diagram of the relationship between an input and an output of the second data transmission circuit of FIG. 6;

FIG. 13 is a diagram of the relationship between an input and an output of the third data transmission circuit of FIG. 7; and

FIG. 14 is a diagram of the relationship between an input and an output of the fourth data transmission circuit of FIG. 8.

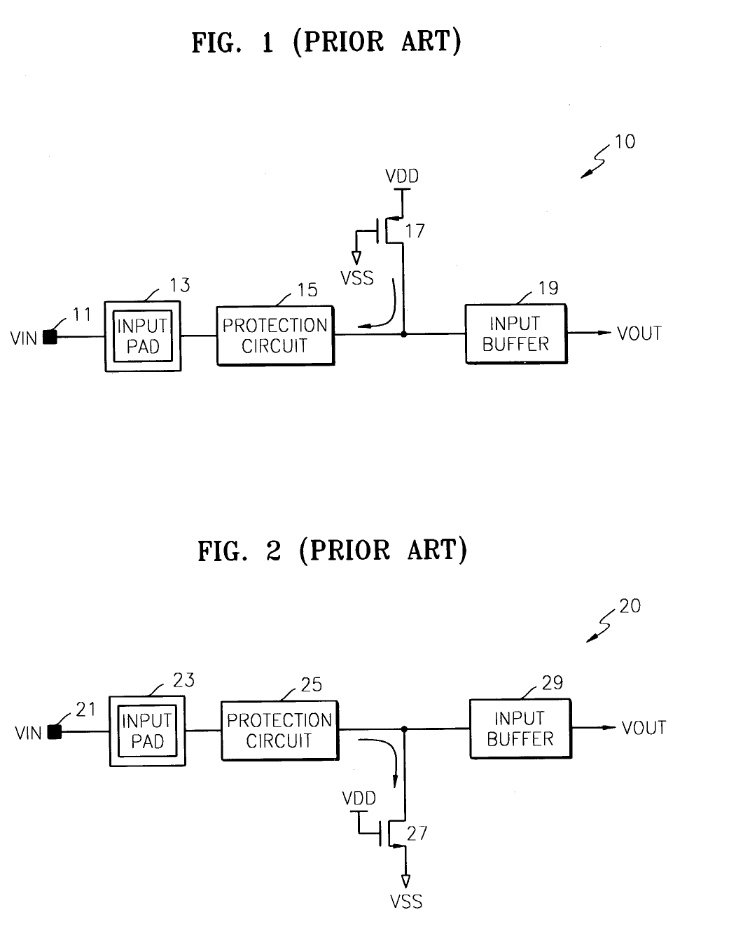

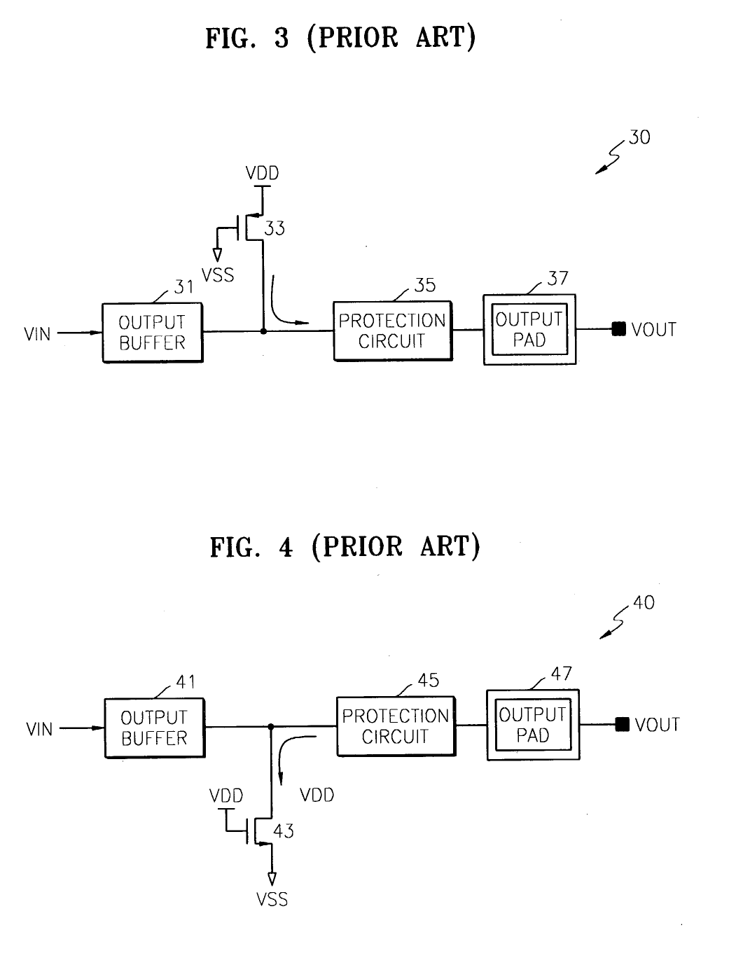

### DETAILED DESCRIPTION OF PREFERRED EMBODIMENTS

The present invention will now be described more fully with reference to the accompanying drawings, in which preferred embodiments of the invention are shown. This invention may, however, be embodied in many different forms and should not be construed as being limited to the embodiments set forth here; rather, these embodiments are provided so that this disclosure will be thorough and complete, and will fully convey the concept of the invention to those skilled in the art. The same reference numerals in different drawings represent the same element.

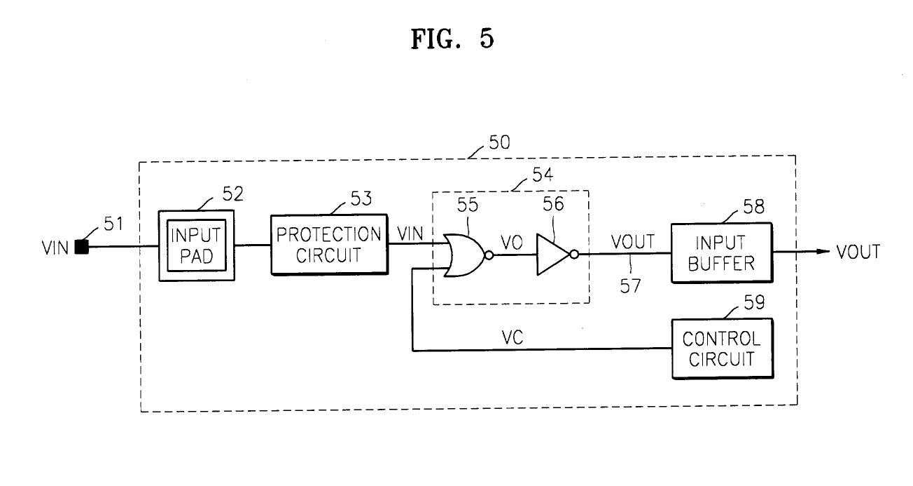

FIG. 5 is a circuit diagram of a first data transmission circuit 50 according to the present invention. Referring to FIG. 5, the first data transmission circuit 50 includes an input pad 52, a protection circuit 53, a transmission circuit 54, an input buffer 58, and a control circuit 59. The transmission circuit 54 includes a pull-up circuit 55 and an inverter 56. The pull-up circuit 55 is realized as an NOR gate.

The first data transmission circuit 50 is embodied as a semiconductor chip to be packaged. An input pin 51 is an external terminal that transmits input data Vin to the first data transmission circuit 50. The input pad 52 is electrically connected to the input pin 51. The first data transmission circuit 50 includes circuitry for inputting and outputting data.

The protection circuit 53 is a circuit that protects internal circuits, such as the transmission circuit 54, the input buffer 58, and the control circuit 59, when excessive voltage is applied to the input pad 52 due to static electricity.

The transmission circuit 54 receives a control signal Vc and input data Vin, and transmits the input data Vin to an output terminal 57 or pulls up the level of the output terminal 57 to the level of a power source depending on the logic level, e.g., a logic ‘high’ level or a logic ‘low’ level, of the control signal Vc.

The input buffer 58 receives an output signal Vout from the transmission circuit 54, buffers the output signal Vout, and outputs the buffered signal. The control circuit 59 outputs the control signal Vc to the pull-up circuit 55 of the transmission circuit 54. The control signal Vc controls transmission of data of the transmission circuit 54.

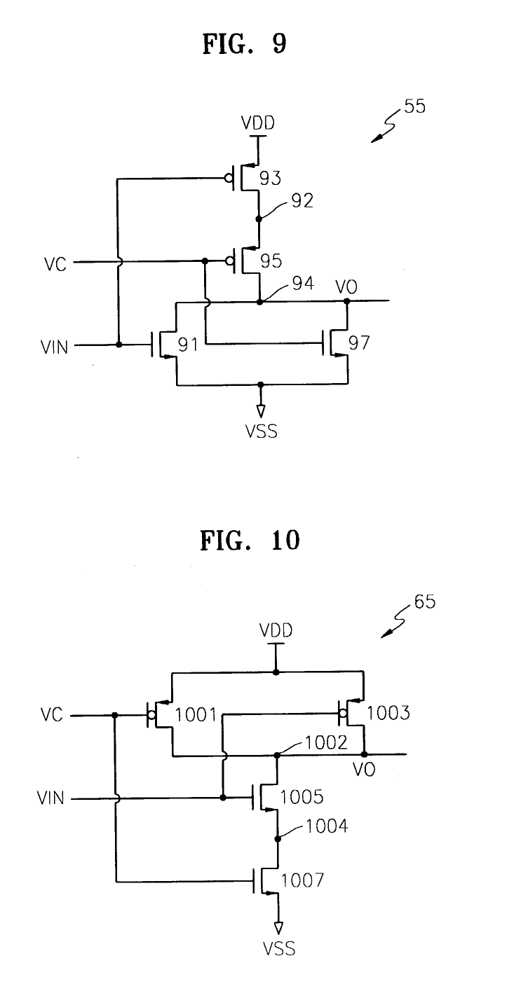

FIG. 9 is a circuit diagram of the pull-up circuit 55 shown in FIG. 5. Referring to FIG. 9, the pull-up circuit 55 includes two PMOS transistors 93 and 95, and two NMOS transistors 91 and 97.

The PMOS transistor 93 is connected between a power source voltage VDD and a node 92 and data Vin is input to the gate of the PMOS transistor 93. The PMOS transistor 95 is connected between the node 92 and a node 94 and a control signal Vc is input to the gate of the PMOS transistor 95. Here, a signal output from the node 94 is Vo.

Each of the NMOS transistors 91 and 97 is connected between the node 94 and a grounding power source VSS, and the data Vin is input to the gate of the NMOS transistor 91. The control signal Vc is input to the gate of the NMOS transistor 97.

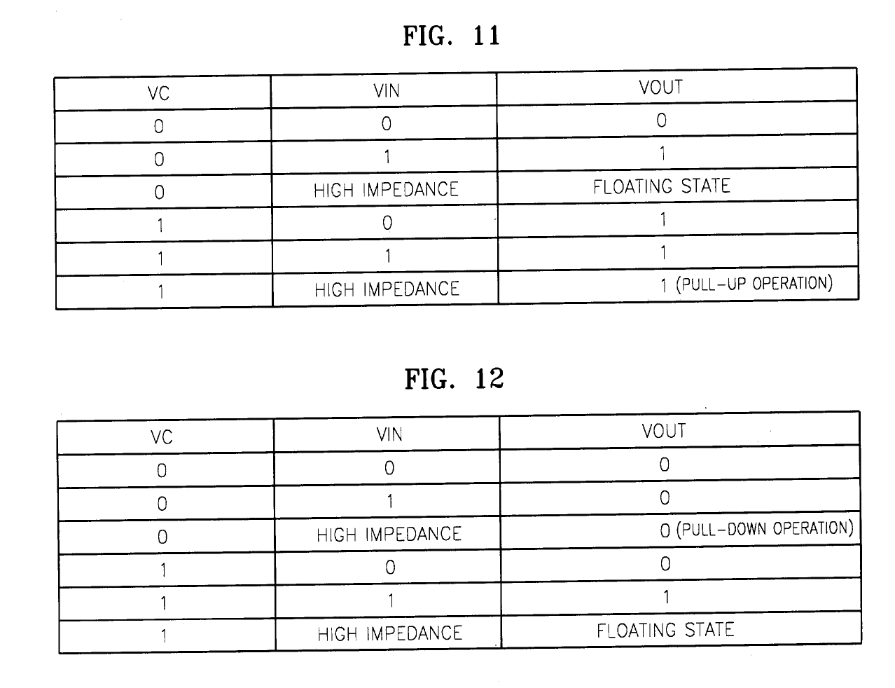

FIG. 11 is a diagram illustrating the relationship between an input and an output of the first data transmission circuit 50 of FIG. 5. The operations of the first data transmission circuit 50 will now be described in detail with reference to FIGS. 5, 9, and 11.

When the control signal Vc is deactivated, i.e., at a logic ‘low’ level, and the data Vin is at a low level, the two PMOS transistors 93 and 95 are turned on and the two PMOS transistors 91 and 97 are turned off.

In this case, the signal Vo output from the node 94 is at a high level and the signal Vout is at a low level. Here, the high level or the level of the power source VDD is indicated with 1, and the low level or the level of the grounding power source VSS is indicated with 0.

The transmission circuit 54 transmits the input data Vin of a low level to the output terminal 57, and then, the input buffer 58 buffers the signal Vout output from the transmission circuit 54 and outputs the signal Vout of a low level.

When the control signal Vc is deactivated and the level of the data Vin is high, the PMOS transistor 93 is turned off and the NMOS transistor 91 is turned on. Therefore, the level of the signal Vo output from the node 94 is low and the level of the signal Vout output from the inverter 56 is high. The transmission circuit 54 transmits the input data Vin of a high level to the output terminal 57, and the input buffer 58 buffers the signal Vout output from the transmission circuit 54 and outputs the signal Vout of a high level.

When the control signal Vc is deactivated and the input pin 51 is open (high impedance), the signal output from the transmission circuit 54 or the first data transmission circuit 50 is unknown in a floating state.

When the control signal Vc is activated, for instance, when the control signal Vc is at logic ‘high’, the NMOS transistor 97 is turned on. In this case, the signal Vo output from the node 94 is at a low level and the signal Vout output from the inverter 56 is at a high level, regardless of whether the level of the data Vin is low or high. Therefore, the signal Vout output from the transmission circuit 54 is at a high level, and the input buffer 58 buffers the signal Vout output from the transmission circuit 54 and outputs the signal Vout of a high level.

If the control signal Vc is activated and the input pin 51 is open (high impedance), the NMOS transistor 97 is turned on. Therefore, the signal Vo output from the node 94 is at a low level and the signal Vout output from the inverter 56 is at a high level, regardless of whether the level of the data Vin is low or high. In this case, the level of the output terminal 57 of the transmission circuit 54 is pulled up to the level of the power source VDD.

In conclusion, the first data transmission circuit 50, which includes the input pad 52 and the output terminal 57, transmits data Vin input to the input pad 52 to the output terminal 57, and pulls up the level of the output terminal 57 to the level of the power source VDD or transmits the input data Vin to the output terminal 57, depending on the logic level of the control signal Vc.

Therefore, even when the input pin 51 is open or the data Vin is input to the input pin 51 according to an application, leakage current is not generated in the first data transmission circuit 50 during transmission of data according to the present invention.

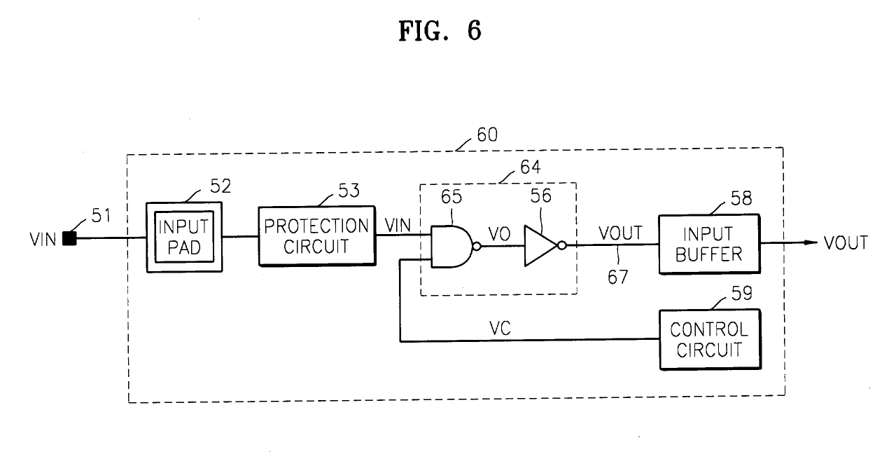

FIG. 6 is a circuit diagram of a second data transmission circuit 60 according to the present invention. Referring to FIG. 6, the second data transmission circuit 60 includes an input pad 52, a protection circuit 53, a transmission circuit 64, an input buffer 58, and a control circuit 59. The second data transmission circuit 60 is embodied as a semiconductor chip.

Input data Vin is sent to the second data transmission circuit 60 via an input pin 51. The transmission circuit 64 includes a pull-down circuit 65 and an inverter 56. The second data transmission circuit 60 also includes circuitry for inputting and outputting data.

FIG. 10 is a circuit diagram of the pull-down circuit 65 of FIG. 6. Referring to FIG. 10, the pull-down circuit 65 acts as an NAND gate. The pull-down circuit 65 includes two PMOS transistors 1001 and 1003, and two NMOS transistors 1005 and 1007.

Each of the PMOS transistors 1001 and 1003 is connected between a power source voltage VDD and a node 1002. A control signal Vc is input to the gate of the PMOS transistor 1001 and data Vin is input to the gate of the PMOS transistor 1003. A signal output from the node 1002 is Vo.

The NMOS transistor 1005 is connected between the node 1002 and a node 1004. The data Vin is input to the gate of the NMOS transistor 1005. The NMOS transistor 1007 is connected between the node 1004 and a grounding power source VSS and the control signal Vc is input to the gate of the NMOS transistor 1007.

FIG. 12 is a diagram illustrating the relationship between an input and an output of the second data transmission circuit 60 of FIG. 6. The operations of the second data transmission circuit 60 will now be described in detail with reference to FIGS. 6, 10, and 12.

When the control signal Vc is in a deactivated state the PMOS transistor 1001 is turned on and the NMOS transistor 1007 is turned off. As a result, the signal Vo output from the node 1002 is at a high level and a signal Vout output from the inverter 56 is at a low level. That is, the signal Vout output from the transmission circuit 64 is at a low level.

When the input pin 51 is open, i.e., in a high impedance state, the signal Vo output from the node 1002 is at a high level and the signal Vout output from the inverter 56 is at a low level. Thus, the level of the output terminal 67 of the transmission circuit 64 is pulled down to the level of the grounding power source VSS.

When the control signal Vc is deactivated and the data Vin is at a low level, the PMOS transistor 1003 is turned on and the NMOS transistor 1005 is turned off. In this case, the signal Vo output from the node 1002 is at a high level and the signal Vout output from the inverter 56 is at a low level. As a result, the transmission circuit 64 transmits the input data Vin to the output terminal 67.

If the control signal Vc is activated and the data Vin is at a high level, the NMOS transistors 1005 and 1007 are turned on. In this case, the signal Vo output from the node 1002 is at a low level and the signal Vout output from the inverter 56 is at a high level. Thus, the transmission circuit 64 transmits the input data Vin to the output terminal 67.

If the control signal Vc is activated and the input pin 51 is open (high impedance), the signal at the node 1002 is unknown in a floating state. Therefore, the second data transmission circuit 60, which includes the input pad 52 and the output terminal 67, transmits the data Vin input to the input pad 52 to the output terminal 67, pulls down the output terminal 67 to the level of the grounding power source VSS or transmits the input data Vin to the output terminal 67, in accordance with the logic level of the control signal Vc.

Thus, according to the present invention, even if the input pin 51 is open or the data Vin is input to the input pin 51 according to an application, leakage current is not generated in the first data transmission circuit 50 during transmission of the input data Vin.

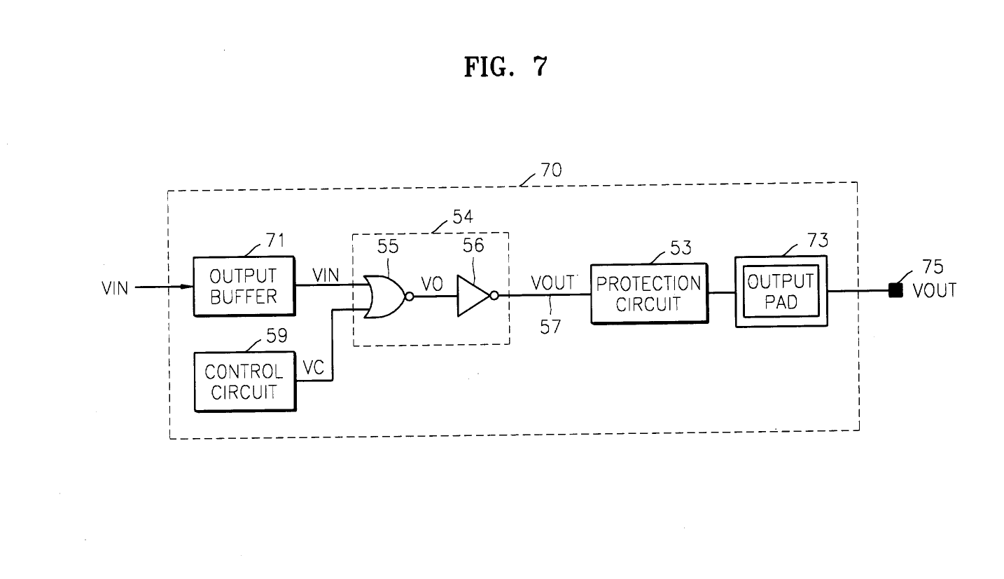

FIG. 7 is a circuit diagram of a third data transmission circuit 70 according to the present invention. Referring to FIG. 7, the third data transmission circuit 70 includes an output buffer 71, a control circuit 59, a transmission circuit 54, a protection circuit 53, and an output pad 73. The transmission circuit 54 includes a pull-up circuit 55 and an inverter 56. The third data transmission circuit 70 is embodied as a semiconductor chip. A signal Vout output from the third data transmission circuit 70 is output to the outside of the semiconductor chip via an output pin 75. The third data transmission circuit 70 also includes circuitry for inputting and outputting data.

The output buffer 71 receives and buffers input data Vin and outputs the buffered signal to the pull-up circuit 55 of the transmission circuit 54. The control circuit 59 outputs the control signal Vc to the pull-up circuit 55. The transmission circuit 54 receives the control signal Vc and the data Vin, and outputs the input data Vin to an output terminal 57 or pulls up the level of the output terminal 57 to the level of the power source voltage in accordance with the logic level of the control signal Vc.

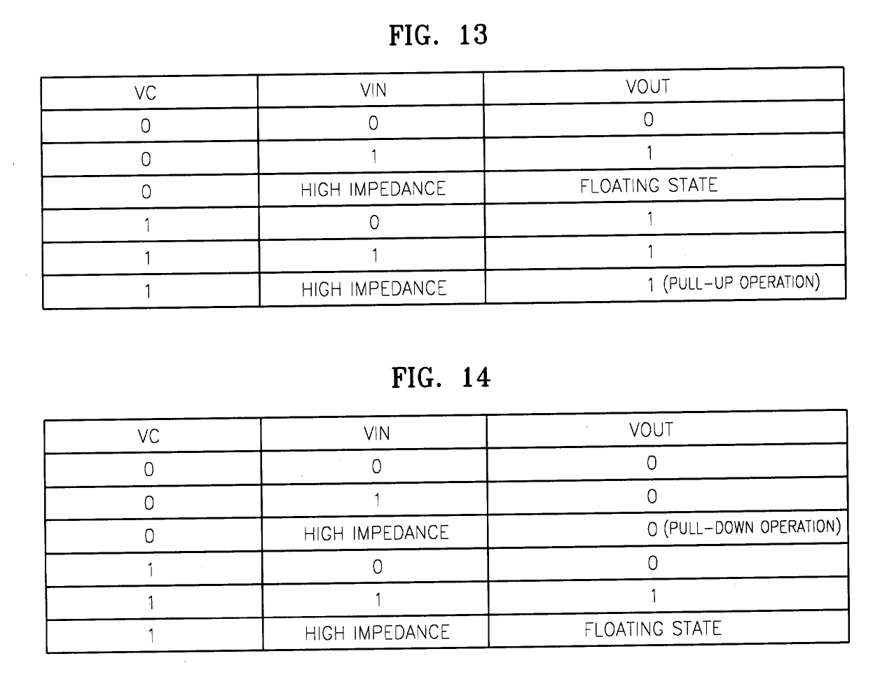

FIG. 9 is a circuit diagram of the pull-up circuit 55 of FIG. 7. FIG. 13 is a diagram illustrating the relationship between an input and an output of the third data transmission circuit of FIG. 7. The operations of the third data transmission circuit 70 will now be briefly described with reference to FIGS. 7, 9, and 13. The operations of the third data transmission circuit 70 are substantially similar to those of the first data transmission circuit 50.

The third data transmission circuit 70 operates in a pull-up mode and a normal mode. The pull-up mode indicates a case where an input terminal of the output buffer 71 is open, that is, when the control signal Vc is activated and the data Vin is not input to the output buffer 71. The normal mode indicates a case where Data Vin of a high or low level is input to the output buffer 71.

The third data transmission circuit 70 pulls up the level of the output terminal 57 to the level of the power source voltage VDD in the pull-up mode, and transmits the input data Vin to the output terminal 57 in the normal mode.

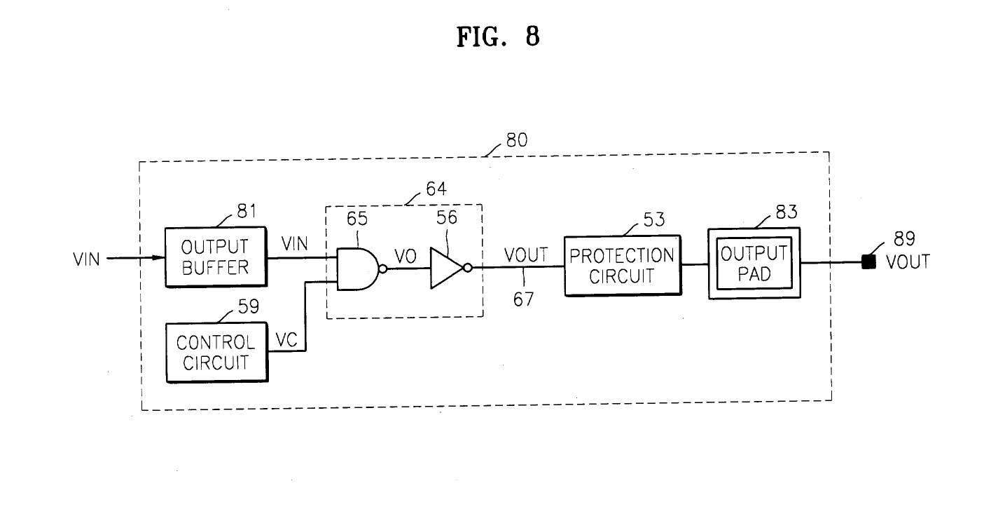

FIG. 8 is a circuit diagram of a fourth data transmission circuit 80 according to the present invention. Referring to FIG. 8, the fourth data transmission circuit 80 includes an output buffer 81, a control circuit 59, a transmission circuit 64, a protection circuit 53, and an output pad 73. The fourth data transmission circuit 80 is embodied as a semiconductor chip. A signal Vout output from the fourth data transmission circuit 80 is output to the outside of a semiconductor chip or a package via the output pin 75.

The fourth data transmission circuit 80 also includes a circuit for inputting and outputting data.

FIG. 10 is a circuit diagram of the pull-down circuit 65 of FIG. 8. FIG. 14 is a diagram illustrating the relationship between an input and an output of the fourth data transmission circuit 80 of FIG. 8. The operations of the fourth data transmission circuit 80 will now be briefly described with reference to FIGS. 8, 10, and 14. The operations of the fourth data transmission circuit 80 are substantially similar to those of the second data transmission circuit 60.

The fourth data transmission circuit 80 operates in a pull-down mode and a normal mode. The pull-down mode indicates a case where an input terminal of the output buffer 81 is open, i.e., the control circuit Vc is deactivated and the data Vin is not input to the output buffer 81. The normal mode indicates a case where the data Vin of a high or low level is input to the output buffer 81.

The fourth data transmission circuit 80 pulls down the level of the output terminal 67 of the transmission circuit 64 to the level of the grounding power source VSS in the pull-down mode, and transmits the input data Vin to the output terminal 67 in the normal mode.

A method of transmitting data input to an input terminal to an output terminal can be easily understood by those skilled in the art with reference to FIGS. 5 through 14. Thus, a detailed description thereof will be omitted.

As described above, a data transmission circuit according to the present invention is advantageous in that leakage current is not generated during transmission of data even if an input pin is open or data is input to the input pin according to an application.

What is claimed is:

1. A data transmission circuit having an input terminal and an output terminal for transmitting data at the input terminal to the output terminal, the data transmission circuit comprising:
a power source node for receiving a voltage at a power source level;
a control circuit generating a control signal; and
a transmission circuit for pulling up a voltage level of the output terminal to the power source level or transmitting the data to the output terminal in response to the control signal.

2. The data transmission circuit of claim 1, wherein the transmission circuit pulls up the voltage level of the output terminal to the power source level in response to the control signal having a logic high level, irrespective of whether the data is being input to the input terminal or the input terminal is open.

3. The data transmission circuit of claim 1, wherein the transmission circuit transmits the data to the output terminal in response to the control signal having a logic low level.

4. A data transmission circuit having an input terminal and an output terminal for transmitting data at the input terminal to the output terminal, the data transmission circuit comprising:
a grounding power source node having a grounding power source level;
a control circuit generating a control signal; and
a transmission circuit for pulling down a voltage level of the output terminal to the grounding power source level or transmitting the data to the output terminal in response to the control signal.

5. The data transmission circuit of claim 4, wherein the transmission circuit pulls down the voltage level of the output terminal to the grounding power source level in response to the control signal having a logic low level, irrespective of whether the data is being input to the input terminal or the input terminal is open.

6. The data transmission circuit of claim 4, wherein the transmission circuit transmits the data to the output terminal in response to the control signal having a logic high level.

7. A method of transmitting data at an input terminal to an output terminal, the method comprising:
receiving a voltage at a power source level;
generating a control signal; and
pulling up a voltage level of the output terminal to the power source level or transmitting the data to the output terminal in response to the control signal.

8. The method of claim 7, wherein transmitting the data comprises pulling up the voltage level of the output terminal to the power source level in response to the control signal having a logic high level, irrespective of whether the data is being input to the input terminal or the input terminal is open.

9. The method of claim 7, wherein during the transmission of the data, the data is transmitted to the output terminal in response to the control signal having a logic low level.

10. A method of transmitting data at an input terminal to an output terminal, the method comprising:
providing a grounding power source level;
generating a control signal; and
pulling down a voltage level of the output terminal to the grounding power source level or transmitting the data to the output terminal in response to the control signal.

11. The method of claim 10, wherein transmitting the data comprises pulling down the voltage level of the output terminal to the grounding power source level in response to the control signal having a logic low level, irrespective of whether the data is being input to the input terminal or the input terminal is open.

12. The method of claim 10, wherein during the transmitting of the data, the data is transmitted to the output terminal in response to the control signal having a logic high level.

13. A data transmission circuit having an input terminal and an output terminal for transmitting data at the input terminal to the output terminal, the data transmission circuit comprising:
a pull-up mode; and
a normal mode,
wherein a voltage level of the output terminal is pulled up to a voltage of a power source level in the pull-up mode and the data is transmitted to the output terminal in the normal mode.

14. The method of claim 13, wherein when the input terminal is open, the voltage level of the output terminal is pulled up to the power source level in the pull-up mode.

15. A method of transmitting data at an input terminal to an output terminal, the method comprising:
checking if a present mode is a pull-up mode or a normal mode; and
pulling up a voltage level of the output terminal to a voltage of a power source level in the pull-up mode and transmitting the data to the output terminal in the normal mode.

16. The method of claim 15, wherein when the input terminal is open, the voltage level of the output terminal is pulled up to the power source level in the pull-up mode.

17. A data transmission circuit having an input terminal and an output terminal for transmitting data at the input terminal to the output terminal, the data transmission circuit comprising:
a pull-down mode; and
a normal mode,
wherein a voltage level of the output terminal is pulled up to a voltage of a power source level in the pull-down mode and the data is transmitted to the output terminal in the normal mode.

18. The method of claim 17, wherein when the input terminal is open, the voltage level of the output terminal is pulled down to the power source level in the pull-down mode.

19. A method of transmitting data at an input terminal to an output terminal, the method comprising:
checking if a present mode is a pull-down mode or a normal mode; and
pulling down a voltage level of the output terminal to a grounding power source level in the pull-down mode and transmitting the data to the output terminal in the normal mode.

20. The method of claim 19, wherein when the input terminal is open, the voltage level of the output terminal is pulled down to the grounding power source level in the pull-down mode.
